(19) United States
(12) Patent Application Publication
(10) Pub. No.: US 2022/0388099 A1
(43) Pub. Date: Dec. 8, 2022

(54) ULTRASOUND-BASED WELDER QUALIFICATION SYSTEM

(71) Applicant: Kimberley Anne Hayes, San Antonio, TX (US)

(72) Inventor: Kimberley Anne Hayes, San Antonio, TX (US)

(21) Appl. No.: 17/833,022

(22) Filed: Jun. 6, 2022

Related U.S. Application Data
(60) Provisional application No. 63/197,229, filed on Jun. 4, 2021.

(51) Int. Cl. B23K 31/12

(52) U.S. Cl. CPC B23K 31/125

(57) ABSTRACT

An ultrasonic-based welder qualification system is disclosed. The ultrasonic-based welder qualification system provides an inclusive inspection cabinet for welder qualification coupons with a development path for machine learning assisted analysis according to relevant codes/standards. Advanced Ultrasonic do not require permitting and the close loop system will provide pre-programmed procedures for auto-examination capabilities. The system can include a roller assembly for supporting a coupon, and a gantry assembly for positioning ultrasonic probes on the coupon. The gantry assembly can include vertical drive members and a horizontal drive member movable along the vertical drive members. The ultrasonic probes can be movably associated along the horizontal drive member. The system can utilize machine learning to analyze weld data for providing rapid weld qualification information. A portable cabinet can house all the components for providing rapid transport to sites.

### CROSS-REFERENCE TO RELATED APPLICATION

This application claims the benefit of priority under 35 U.S.C. § 119(e) based upon co-pending U.S. provisional patent application Ser. No. 63/197,229 filed on Jun. 4, 2021. The entire disclosure of the prior provisional application is incorporated herein by reference.

### BACKGROUND

### Technical Field

The present technology relates to an ultrasound-based welder qualification system for use in connection with automated rapid inspection and delivery of welder performance results during training in accordance with certification parameters. Further, the present technology can relate to reducing the use of radiography and destructive bend testing method, while providing reliable and repeatable feedback loop data of welder performance results.

Embodiments of the invention described in this specification relate generally to welder qualification testing and training, and more particularly, to an ultrasound-based welder qualification system.

### Background Description

In the American Welders Society (AWS) and United Association (UA) the welding craft personnel is trained in specific or broad welding skills. The performance qualification test on the test coupons is in accordance to a qualified welding procedure and will be used to determine the welder can produce sound welds for given fabrication requirements. Welding qualification tests (WQT) include, but are not limited to, (i) Welding Procedure Specification (WPS) encompassing all the welding parameters (welding current, voltage, base material, filler/electrode etc.) in accordance to the qualified welding procedure, (ii) welding process will be qualified individually for various processes (SMAW, MIG, TIG), (iii) size of test coupon will be specific to standards to assess positioning, durability performance (widely accepted codes are AWS D1.1 and ASME BPVC, Section), (iv) position of the test coupon with gradient levels of difficulty and inclusion (1G-6G or 1F-6F), and (v) filler metal/electrode.

Current solutions for evaluations of welder qualifications are outsourced third-party radiographic film and/or destructive bend test. Some companies may have in-house evaluation capabilities, which requires costly permitting. In particular, performance validations are currently based on two primary inspection methods: (1) non-destructively using Radiographic Testing (RT) of the film or digital X-Ray is performed by a certified inspection lab/personnel requiring hazardous radiography source system and permitting and (2) a destructive test method for assessing mechanical properties in the weld, heat affected zone (HAZ) with respect to the base material. However, contracted radiographic examination usually takes a minimum of 24 hours for results to get to welder and may be costly. Furthermore, this kind of evaluation is often performed with film radiography, therefore, there is no digital record of coupon evaluation. This means that the results are only pass or fail. It does not provide details/specifics to personnel related to the reason for failure. In some cases, the welder does receive some details like if the failure is based on porosity, slag, etc. but not all the data is sometimes provided. Further, the delay in receiving the failure details from when the welder conducted the test can be difficult for the welder to understand or remember as significant time may have passed and the welder may not remember what they were doing at the time of the weld discontinuity. Therefore, there is no 3D export with discontinuity annotation and other digital records of coupon evaluation. The destructive bend test may not be in the area of concern or potential discontinuity and render the coupon unable to reuse.

Advanced Ultrasonic do not require permitting and the close loop system will provide pre-programmed procedures for auto-examination capabilities. Further, deployment of advanced ultrasonic technologies does not require permitting by the state since it does not involve hazardous materials unlike radiography that utilizes Isotopes. This closed loop ultrasonic pattern system will provide pre-programmed procedures for auto-capabilities. Thus, industries migrate away from costly RT with the use of provisions allowing ultrasonic testing (UT) as an alternative. Further, the use of RT can be hazardous. Both methods are approved volumetric inspection methods, but detection principles differ in physics and in discontinuity detections (further explained below). The 2-dimensional discontinuity detections of RT are excellent in finding slag and inclusions due to the density variations visibly observed in the through passage of the x-rays. Further, the 2-dimensional discontinuity detections of RT are excellent in finding porosity. While the 3-dimensional acoustic detections are well suited for lack of sidewall fusion and cracks (often missed by RT).

Also, industry challenge in North America impacts project performance where welding is required such as pipeline or facility fabrication due to the welder's being measured against alternate metrics in training then field expectations impose more sensitive methods and increased detection of rejectable discontinuities such as lack of sidewall fusion and cracking.

### SUMMARY

In view of the disadvantages inherent in the known types of welding qualification tests or systems now present in the prior art, the present technology provides a novel ultrasound-based welder qualification system, and overcomes one or more of the mentioned disadvantages and drawbacks of the prior art. As such, the general purpose of the present technology, which will be described subsequently in greater detail, is to provide a new and novel ultrasound-based welder qualification system and method which has all the advantages of the prior art mentioned heretofore and many novel features that result in an ultrasound-based welder qualification system which is not anticipated, rendered obvious, suggested, or even implied by the prior art, either alone or in any combination thereof.

According to one aspect, the present technology can include a weld qualification system including a roller assembly, a gantry assembly and ultrasonic probes. The roller assembly can include multiple rollers each configured to rotatably support a coupon placed thereon, with the coupon including a weld. The gantry assembly can include one or more vertical drive members and a horizontal drive member movable along the one or more vertical drive members. The ultrasonic probes can be movably associated along the horizontal drive member. The ultrasonic probes can be configured to contact an exterior surface of the coupon when supported by the roller assembly.

According to another aspect, the present technology can include a weld qualification system including a roller assembly, a gantry assembly, ultrasonic probes, and a liquid pump. The roller assembly can include multiple rollers each configured to rotatably support a coupon placed thereon, with the coupon including a weld. A roller motor can be operably connected to any one of or any combination of the rollers. The gantry assembly can include one or more vertical drive members and a horizontal drive member movable along the one or more vertical drive members. The ultrasonic probes can be movably associated along the horizontal drive member with the weld positioned between the ultrasonic probes. The ultrasonic probes can be configured to contact an exterior surface of the coupon when supported by the roller assembly. The liquid pump can be configured to pump a liquid from an area below the coupon to the exterior surface of the coupon adjacent the ultrasonic probes.

According to yet another aspect, the present technology can include a method of using a weld qualification system for inspecting a weld on a coupon for determining welder qualification. The method can include the steps of placing the coupon on a roller assembly.

Activating a gantry assembly to position ultrasonic probes to contact an exterior surface of the coupon adjacent the weld. Rotating the coupon. Activating the ultrasonic probes. Imaging the weld utilizing the ultrasonic probes to create weld data. Then, determining a welder qualification based on the weld data.

According to still yet another aspect, the present technology can include a non-transitory computer readable medium with an executable program stored thereon comprising instructions for execution by at least one processing unit for inspecting a weld on a coupon for determining welder qualification. The instructions when executed by the at least one processing unit can cause the at least one processing unit to activate any one of or any combination of a vertical drive motor and a horizontal drive motor of a gantry assembly to position ultrasonic probes to contact an exterior surface of the coupon adjacent the weld. Then to activate a roller motor operably connected to one or more rollers of a roller assembly to rotate the coupon supported on the roller assembly. Then activate the ultrasonic probes and image the weld utilizing the ultrasonic probes to create weld data. Next, to determine a welder qualification based on the weld data.

In some or all embodiments, the one or more vertical drive members can be at least two vertical drive members in a spaced apart relationship with the coupon located therebetween.

In some or all embodiments, each of the vertical drive members can include a vertical block configured to travel therealong upon rotation of at least one of the vertical drive members by a vertical drive motor.

In some or all embodiments, the horizontal drive member can include a horizontal block configured to travel therealong upon rotation of the horizontal drive member by a horizontal drive motor. The horizontal drive member can be operably connected to the vertical block of each of the vertical drive members so that vertical motion of the vertical block translates into vertical motion of the horizontal drive member.

In some or all embodiments, the ultrasonic probes can be operably connected to the horizontal block by away of a pivot connection.

In some or all embodiments, each of the vertical drive members can include one or more vertical guide members configured to guide the vertical block as it travels along the vertical drive members includes, respectively.

In some or all embodiments, each of the ultrasonic probes can be movably associated with the horizontal drive member and each being configured for contact with the exterior surface of the coupon on opposite sides of the weld.

In some or all embodiments, one or more of the rollers can be rotatably driven by a roller motor.

Some or all embodiments of the present technology can include a computer system including at least one processing unit operably connected or connectable to the gantry assembly and the ultrasonic probes, The at least one processing unit can be configured or configurable to control the gantry assembly, the ultrasonic probes, and to process data received from the ultrasonic probes.

Some or all embodiments of the present technology can include a liquid pump configured to pump a liquid from an area below the coupon to the exterior surface of the coupon adjacent the ultrasonic probes.

Some or all embodiments of the present technology can include a cabinet including a bottom section configured to receive or store the liquid, and a coupon receiving section configured to receive the coupon.

Some or all embodiments of the present technology can include the step of operating one or more vertical drive motors to rotate one or more vertical drive members of the gantry assembly to vertically move a vertical block along the vertical drive members.

Some or all embodiments of the present technology can include the step of operating a horizontal drive motor to rotate a horizontal drive member of the gantry assembly to horizontal move a horizontal block along the horizontal drive member. The horizontal drive member can be operably connected to the vertical block of the vertical drive members so that vertical motion of the vertical block translates into vertical motion of the horizontal drive member.

Some or all embodiments of the present technology can include the step of operating a roller motor that is operably connected to one or more rollers of the roller assembly to rotate the coupon supported on the roller assembly.

Some or all embodiments of the present technology can include the step of analyzing the weld data utilizing a computer system including at least one processing unit operably connected or connectable to the ultrasonic probes.

Some or all embodiments of the present technology can include the step of analyzing the weld data by the computer system utilizing any one of or any combination of one or more machine learning algorithms and one or more machine learning statistical models.

Some or all embodiments of the present technology can include the step of operating a liquid pump to deliver a liquid to the exterior surface of the coupon adjacent the ultrasonic probes.

In some or all embodiments, the ultrasonic probes can be two or more ultrasonic probes.

A novel ultrasound-based welder qualification system is disclosed. In some embodiments, the ultrasound-based welder qualification system includes an encoded, rotation coupon manipulation inspection station with an ultrasonic probe placement system for welder qualification coupons. The development path for machine learning assisted analysis according to relevant codes/standards and are supported through the controlled data collection repository from placed systems. In some embodiments, the ultrasound-based welder qualification system uses machine leaning algorithms for automated assisted analysis in accordance to support accepted industry standards. In some embodiments, the ultrasound-based welder qualification system delivers code/standard evaluation onsite for a welder during training, performance demonstrations, and evaluation for near real-time feedback loop to welder for increased arc-time and development for the welder.

In some embodiments, the code/standard evaluation can be code/standard-compliant evaluations. Further in some embodiments, the evaluation can be associated with a level III certification.

According to an aspect of the present technology, a close-loop ultrasound-based welder qualification system comprises: an inspection system comprising a metal framed inspection cabinet with a coupon slot, a rotating encoded caster coupling movement system, an ultrasonic probe positioning system, and a computing device configured to run a software program as a predefined procedure selection system to trigger cabinet mobility function for data acquisition and post-processing review of acquired data; a welder qualification coupon that a welder provides into the coupon slot of the inspection cabinet for welder evaluation; a machine learning module that implements at least one machine learning algorithm in Python code for automated assisted analysis in accordance with accepted industry standards; and a computer aided design (CAD) device and three-dimensional (3D) modeling system that is populated with data acquired and encoded for output to render 3D representations of the automated assisted analysis in connection with the welder qualification coupon used for evaluation.

According to one aspect, the present technology can be a close-loop ultrasound-based welder qualification system including an inspection system, a welder qualification coupon, a machine learning module, and a computer aided design (CAD) device. The inspection system can include a metal framed inspection cabinet with a coupon slot, a rotating encoded caster coupling movement system, an ultrasonic probe positioning system, and a computing device configured to run a software program as a predefined procedure selection system to trigger cabinet mobility function for data acquisition and post-processing review of acquired data. The welder qualification coupon that a welder provides into the coupon slot of the inspection cabinet for welder evaluation. The machine learning module that implements at least one machine learning algorithm in Python code for automated assisted analysis in accordance with accepted industry standards. The computer aided design (CAD) device and three-dimensional (3D) modeling system that is populated with data acquired and encoded for output to render 3D representations of the automated assisted analysis in connection with the welder qualification coupon used for evaluation.

In some embodiments, the computer aided design (CAD) device can be simulation visualization. Further in some embodiments, the coupon slot can be a placement envelope. Still further in some embodiments, the rotating encoded caster coupling movement system can be an encoded caster-driven coupon rotation system.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of at least some of the embodiments of the present technology to provide a new and novel ultrasound-based welder qualification system that has all of the advantages of the prior art welding qualification tests or systems and none of the disadvantages.

It is another object of at least some of the embodiments of the present technology to provide a new and novel ultrasound-based welder qualification system that may be easily and efficiently manufactured and marketed.

An even further object of at least some of the embodiments of the present technology is to provide a new and novel ultrasound-based welder qualification system that has a low cost of manufacture with regard to both materials and labor, and which accordingly is then susceptible of low prices of sale to the consuming public, thereby making such ultrasound-based welder qualification system economically available to the buying public.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the claimed present technology is not limited to meeting most or all of the objects identified and that some embodiments of the present technology may meet only one such object or none at all.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a block diagram of a macro system embodiment of the ultrasound-based welder qualification system constructed in accordance with the principles of some embodiments of the present technology.

FIG. 2 is a block diagram view of the ultrasound-based welder qualification system of some embodiments of the present technology.

FIG. 3 is a perspective view of the ultrasound-based welder qualification system of the present technology.

FIG. 4 is a cross-sectional view of the ultrasound-based welder qualification system taken along line 4-4 in FIG. 3.

FIG. 5 is an enlarged cross-sectional view of the ultrasonic probe horizontal positioning system of some embodiments of the present technology taken along line 5-5 in FIG. 4.

FIG. 6 is a flowchart of a method according to some embodiments.

FIG. 7 is a flowchart of a workflow method according to some embodiments.

FIG. 8 illustrates an exemplary electronic computing device that can be used to practice aspects of the present technology.

The same reference numerals refer to the same parts throughout the various figures.

### DETAILED DESCRIPTION OF THE EMBODIMENTS

Welder qualification coupons are used to qualify welders where RT along with the destructive bend test are the primary methods before work can be done on a project such as, but not limited to, energy and other refineries facilities. These coupons are what the welder is to use for quality testing, such as two pipe segments with a specific bevel that is defined in the construction codes such as the American Society of Mechanical Engineers (ASME) or other code standards. It can be appreciated that the 280 union halls and trade schools in North America use coupons and test methods. Over the past decades, radiographic film processing versus digital has maintained 85% film processing. Remote third-party inspection companies often perform the evaluation either onsite at the facility (which required increased costs for permitting and potential source management) or the coupons are sent to their facility often in batches that can present delays in pass/fail results to the welders.

Another concern impacting performance, productivity, and prices when new welders enter the industry, are that the evaluation metrics are to pass radiography which is often film. As more and more jobs are using Phased Array Ultrasonic Testing (PAUT) in lieu of RT, for example in the nuclear industry, the welder often fails performance tests with ultrasonics due to the different discontinuities it detects. RT presents 2D discontinuities, and the bend-test does not focus on the complete circumference of the weld. PAUT detects 3D indications/reflectors as sound waves are angled by a time sequencing pulse. This easily detects the lack of sidewall fusion and cracks and can inspect the entire weld in a single pass without chemicals, radiation, or processing time. Additionally, domestic welders often have an adaptive period when they are placed on jobs where PAUT in lieu of Radiography is performed. This can have a significant impact on-time schedules, initially reject rates, and overall costs of the projects. Embracing ultrasonic inspections early in the training process can amend the overall skill mismatch while increasing productivity through faster feedback and developing inspection methods widely used in the nuclear industry.

Welder certifications with RT are slow, as radiographs are time-consuming with the potential day turnaround at best from the third-party non-destructive testing companies. Another concern is that the welder is trained to pass radiography, but not necessarily the discontinuities picked up by advanced ultrasonics like a phased array. RT is excellent for porosity as the density difference is significant enough but misses cracks and lack of sidewall fusion.

Another disadvantage of using film radiography is that the film must be stored in a controlled environment and often the welder just receives a report. As digitalization becomes increasingly important migrating away from film radiography will occur. As such, PAUT is a viable option for traceability of welder evaluation/certification at production that can be linked directly to the NDE method, inspector, and report for end-to-end linkage at every weld.

The continued reliance on radiography to certify welders has created a dilemma for the welding industry. The resulting problem, however, is that PAUT and RT have different sensitivity to the various defects that can be generated where RT does not distinguish depth and PAUT can meet workmanship acceptance criteria. RT can be used to detect density differences as the radiation passes through the specimen and is very useful for finding imperfections like porosity, slag, and undercuts that are mass-based distinctions. It uses diffracted, high-frequency sound beams that can not only detect mass-based defects but can also detect non-mass defects like cracks and lack of sidewall fusion. As a result, welders are trained to meet the detection capabilities of the radiographic method versus one that is transitioning into widespread use for production quality control.

A couple of industry trends have been recognized that impact the fabrication and maintenance through the welding trade. One of these trends is that the welding industry is losing a vital workforce, as stated in The American Welding Society that estimates there will be a shortage of more than 400,000 welders by 2024. This lack of position fulfillment is even more exacerbated in that these positions are not backfilled with the younger generation.

Another trend is that welders are trained to pass radiography tests and fail when put on a job using ultrasonics in lieu of radiography. Technology is not bridging the gap between skill and need in the digital transformation.

Current condition systems may include bend test, which is a sampling of areas that may/may not represent total skill/performance, or third-party RT which may be costly, including time delay and not representative of the project evaluation process

Therefore, what is needed is an alternative quality evaluation/inspection method closer to the welder craft during training, performance demonstrations, and evaluation.

While the above-described devices fulfill their respective, particular objectives and requirements, the aforementioned devices or systems do not describe an ultrasound-based welder qualification system that allows automated rapid inspection and delivery of welding during training in accordance with certification parameters. The present technology additionally overcomes one or more of the disadvantages associated with these known systems by utilizing an adjustable ultrasonic probe assembly in an automated process to rapidly provide weld quality data to a welder, instructor and/or other third party.

A need exists for a new and novel ultrasound-based welder qualification system that can be used for automated rapid inspection and delivery of welding during training in accordance with certification parameters. In this regard, the present technology substantially fulfills this need. In this respect, the ultrasound-based welder qualification system according to the present technology substantially departs from the conventional concepts and designs of the prior art, and in doing so provides an apparatus primarily developed for the purpose of automated rapid inspection and delivery of welding during training in accordance with certification parameters.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

In the following detailed description of the invention, numerous details, examples, and embodiments of the invention are described. However, it will be clear and apparent to one skilled in the art that the invention is not limited to the embodiments set forth and that the invention can be adapted for any of several applications.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Generally, the present disclosure pertains to apparatus, systems and/or methods for automated rapid inspection and delivery of welder performance results during training in accordance with certification parameters.

Some embodiments include an ultrasound-based welder qualification system. In some embodiments, the ultrasound-based welder qualification system utilizes a close-loop ultrasonic testing inspection system in lieu of radiographic testing and mechanical bend tests. In some embodiments, the ultrasound-based welder qualification system includes an inspection coupon manipulation system with an ultrasonic probe placement system for welder qualification coupons with a development path for machine learning assisted analysis according to relevant codes/standards. In some embodiments, the ultrasound-based welder qualification system uses acquired data to refine the machine learning algorithms for the automated assisted analysis in accordance with accepted industry standards. In some embodiments, the cabinet entails an enclosed mechanical encoded rotation system for coupon placement, a probe positioning device with water/coolant effluent removal. In some embodiments, the ultrasonic probe is part of an advanced ultrasonic pulsing system.

In some embodiments, the ultrasound-based welder qualification system also includes a computing device with a software implementation of the process (“system software”) for specific coupon selection and acquisition of data. In some embodiments, the system software includes a recipe-driven coupon selection interface. In some embodiments, the ultrasound-based welder qualification system connects to a Computer Aided Device (CAD) 3-dimensional modeling system. Thus, following acquisition, the encoded data output populates into the CAD 3-dimensional modeling system. Subsequent validation efforts are performed via machine learning. In some embodiments, the ultrasound-based welder qualification system uses Python-based machine learning algorithms for automated assisted analysis in accordance to accepted industry standards. In some embodiments, the machine learning provides auto-detection plot for discontinuities. It can be appreciated that use of other machine learning algorithms in place of Python-learning may be utilized with some embodiments of the present technology.

In some embodiments, the ultrasound-based welder qualification system delivers code/standard evaluation onsite for a welder during training, performance demonstrations, and evaluation. In some embodiments, the onsite ultrasound-based welder qualification system provides external cloud connectivity for enhanced development of the algorithms accuracy. The additional feedback can be provided at the Union Hall level for student performance metrics to enhance training program.

As stated above, current solutions for welder qualifications are outsourced 3rd party radiographic film and/or destructive bend tests. Embodiments of the invention described in this specification solve such problems by an ultrasound-based welder qualification system that is a self-contained mechanical ultrasonic solution not requiring permitting or third party execution, but provides onsite feedback closer to the welder to elevate the craft.

Embodiments of the ultrasound-based welder qualification system described in this specification differ from and improve upon currently existing options. In particular, some embodiments differ by providing faster feedback of inspection, digital results, and data tracking for institution executing training. The controlled data acquisition strategy provides purer ground-truth data files for training/programming development of AI/ML. In addition, the ultrasound-based welder qualification system of some embodiments utilizes a close-loop ultrasonic testing inspection system in lieu of radiographic testing and mechanical bend tests. Also, radiographic testing and bend tests work in the legacy fashion, destructive and two-dimensional, but the ultrasound-based welder qualification system described in this specification elevates the speed and provides 3D results.

The ultrasound-based welder qualification system of the present disclosure may be comprised of the following elements. This list of possible constituent elements is intended to be exemplary only and it is not intended that this list be used to limit the ultrasound-based welder qualification system of the present application to just these elements. Persons having ordinary skill in the art relevant to the present disclosure may understand there to be equivalent elements that may be substituted within the present disclosure without changing the essential function or operation of the ultrasound-based welder qualification system.

1. Procedure selection for specific weld coupon and acceptance criterion from connected computer system

2. Open the front door for access to the inside rotation mechanism centered between casters

3. Close the cabinet door

4. Once system is set properly and sealed, engage from the computer that is connected to the internal mechanism

5. Ultrasonic probe mechanism moves to be placed over centerline of both sides of the weld

6. One/two drive wheels drives circumferential rotate the pipe and encoder wheel tracks the position throughout rotation with an inch overlap

7. Once complete the ultrasonic probe mechanism returns to the home position

8. Cabinet door releases

9. Acquired data imports into evaluation software

10. After a defined acquisition for variation of pipe weld coupons data will be aggregated to train ML

11. After ML is trained, auto reporting of welder performance will grade the results and CAD drawing display for visualized plotted results

The various elements of the ultrasound-based welder qualification system of the present disclosure may be related in the following exemplary fashion. It is not intended to limit the scope or nature of the relationships between the various elements and the following examples are presented as illustrative examples only. The enclosure houses the rotation system for the coupons, a separate program engages the positional system. The software on the computer engages the acquisition software, the probe mechanism and the encoded rotation system. The retraction of the probe mechanism and release of cabinet safety feature.

The ultrasound-based welder qualification system of the present disclosure generally works as a standalone unit that collectively receives the welder qualification coupon, rotates, positions probes, acquires the data and releases. Uploading the data for assisted analysis annotation for rapid compliance response to a welder with visual CAD-like representation for increased insight into craft/skill. In some embodiments, a computing device drives the overall process, sub routines are the locking/unlocking safety mechanism, subroutine synced with the rotation system and import into the computer. In some embodiments, the AI/ML modules are implemented as a subsequent process, taking the exported data as data to train the machine learning aspect.

To make the ultrasound-based welder qualification system of the present disclosure, one would provide a closed cabinet that houses a caster rotation system entailing 1/2 drive wheels and one encoder wheel for data tracing. The auto probe placement system will be engaged from the remote laptop computing device that engages once a coupon is placed and the cabinet is securely closed. The exported data will be used to train machine learning for assisted analysis. The implementation of the software system will also allow remote access for performance analytics. The mechanical components include at least the cabinet, casters (drive and encoder), couplant/water delivery system, probes contoured to appropriate diameters (2″-10″). Digital aspects include a computer, pulser module and offsite communications. Probe assemblies typically preferred as being interchangeable to accommodate proper coupling on various diameters. The auto probe placement system can be engaged from a computing onboard system that engages once a coupon is placed and the cabinet is securely closed.

To use the ultrasound-based welder qualification system of the present disclosure, a welder would provide a coupon to the cabinet and begin the evaluation. This is preferred over the current welder qualification processes which require 2D radiography performed by a certified 3rd party and often invoke a time delay before feedback offered to welder, while the other validation process (bend test) is destructive in nature.

Additionally, the ultrasound-based welder qualification system may be adapted for use and utilized in field industrial inspection systems. Also, the ultrasound-based welder qualification system can provide performance data analytics for global training metrics and increased design capabilities.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

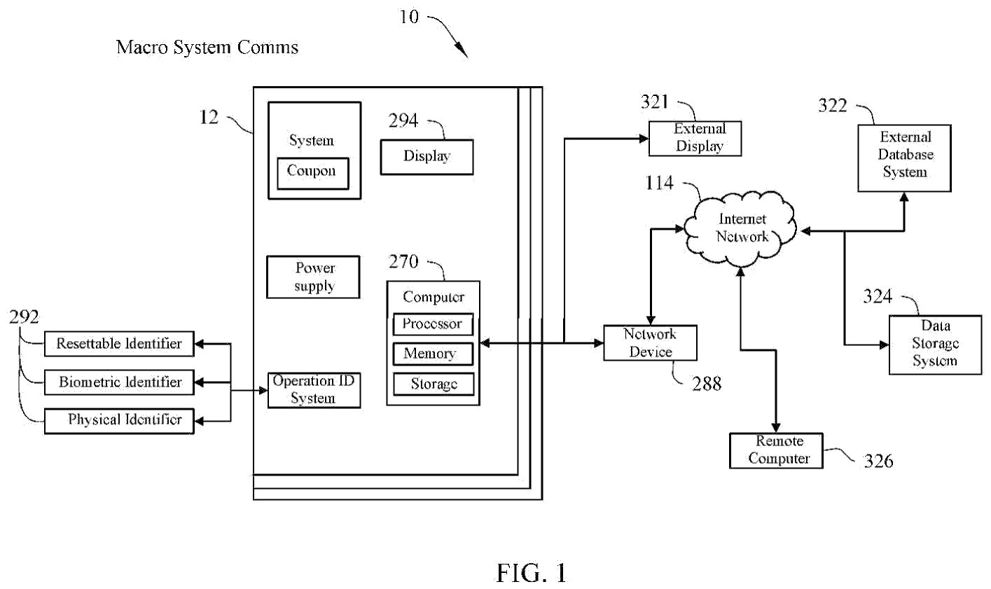

Referring now to the drawings, and particularly to FIGS. 1-8, an embodiment of the ultrasound-based welder qualification system of the present technology is shown and generally designated by the reference numeral 10.

In FIG. 1, a new and novel ultrasound-based welder qualification system and method 10 of the present technology for automated rapid inspection and delivery of welder performance results during training in accordance with certification parameters is illustrated and will be described. More particularly, the ultrasound-based welder qualification system 10 can include a welder qualification coupon evaluation system 12, a computer system 270 operably in communication with the internet and/or network 114 by way of a network interface device 288 associated with or in communication with the computer system 270. The system 12 can include a display or touchscreen 294, and an operation ID system that is configured to received identifying information of a user from one or more identifiers 292 such as, but not limited to, a resettable identifier, a biometric identifier, and/or a physical identifier. A power supply can be incorporated with the system 12 or power can be supplied to the system 12 remotely.

The present technology provides a safe and reliable system capable of being near the welder for visualization of discontinuities in almost real-time. The present technology can utilize a portable, compact advanced ultrasonic inspection system 12, that can include a 2-axis or 3-axis gantry system for ultrasonic probe placement for a variety of diameters of welding coupons. Examples of coupon diameters can be, but are not limited to, between 2-10 inches in accordance with welder qualifications in ASME Section IX. The gantry system can be driven by procedures pre-programmed or inputted in the computer system 270, and can provide placement of phased array ultrasonic probes with height and width manipulability to accommodate variations of the coupon. The ultrasonic probes can have an onboard pulser/receiver module. The display 294 can provide an exported rendering in Computer Assisted Design (CAD) or equivalent for intuitive visualization for the welder.

It can be appreciated that since the present technology utilizing a nonhazardous solution (advanced ultrasonics), then the system 12 can reside next to the welder without hazardous permitting requirements of RT. The present technology can provide a gateway to developing an AI-discontinuity detection program from controlled (scanning and part) for the faster feedback loop to the welder with visualization software. Accordingly, the present technology leverages machine learning and the advantages of PAUT for rapid weld quality and welder certification determination.

The rapid nature of the present technology removes the delayed turnaround for results as per current evaluation systems, which avoids the continued poor quality performances of welders as they wait for their results.

An external display 321 can be in operative communication with the computer system 270 for controlling the system 12 and/or viewing information from the computer system 270.

The computer system 270 can be in operative communication with an external database system 322, a data storage system 324 and/or a remote computer 326 utilizing the internet and/or network 114 for communication and/or data transfer.

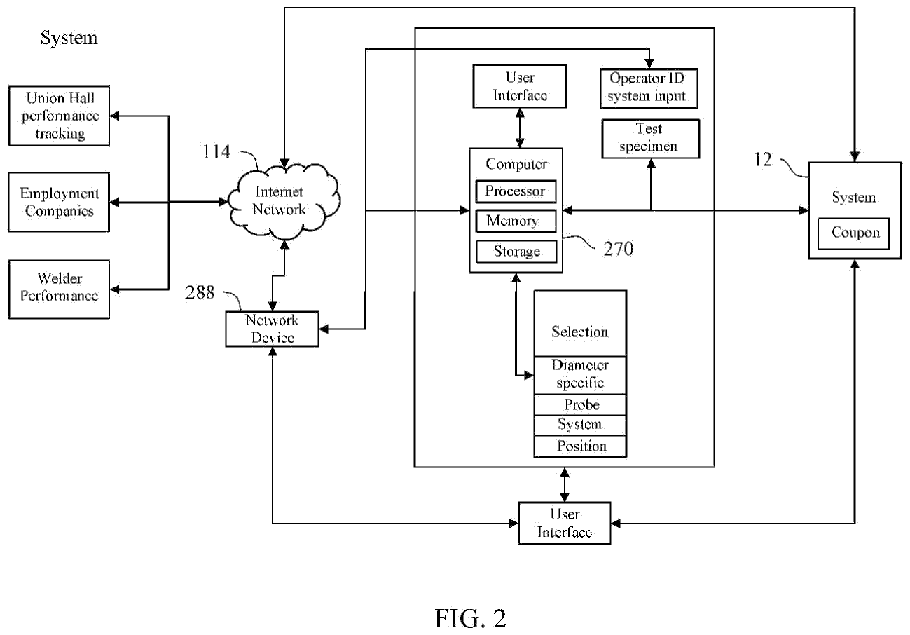

Regarding FIG. 2, the system 12 can be in direct communication with the internet and/or network 114 and with a user interface that is in operative communication with the computer system 270. The computer system 270 and the user interface can both be in operative communication with the network interface device 288, which is then in communication with the internet and/or network 114.

The computer system 270 can include a user interface, and can be configured to provide and/or receive operator ID system input and selectable parameters. The selectable parameters can be, but not limited to, diameter or dimensional data of the coupon, ultrasonic probe data, general system data, and/or position data. Further information regarding a specimen can be provided to the computer system 270.

Any or all information from the system 12 and/or the computer system 270 can be provided to one or more third parties such as, but not limited to a union hall performance tracking system, employment companies, welder performance, government agencies, etc.

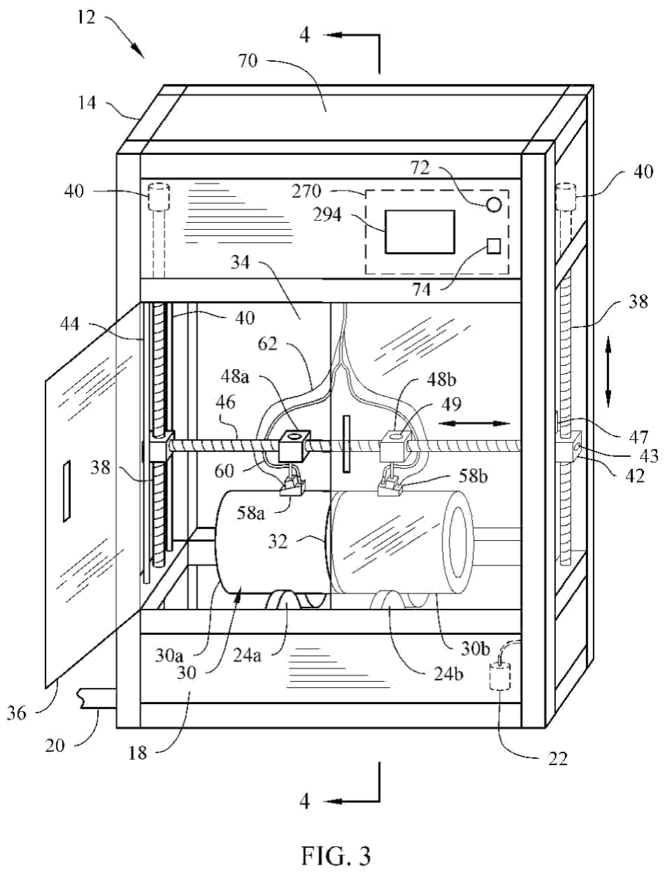

With reference to FIG. 3, the welder qualification coupon evaluation system 12 can include a cabinet 14 provided with a frame support structure 16 that can distinguish the cabinet 14 into a drain pan or bottom section 18, a coupon receiving section 34, and a top section 70. In the exemplary, the frame 16 can be a plurality of interconnectable T-slot or other type of rails configured to receive panels for defining or separating each of the sections 18, 34, 70. The system 12 can be a fully integrated, stand-alone, desktop system that allows for welder qualification coupon evaluation utilizing advanced ultrasonics with plane-wave and total focusing method reconstruction.

The bottom section 18 can have an interior chamber defined by wall panels and configured to retain a liquid such as water. A drain port or pipe 20 can be in communication with the interior chamber of the bottom section 18 allowing for any liquid to be removed therefrom. A liquid pump 22 can be positioned in the bottom section 18 and can be configured to pump liquid from the bottom section 18 for use with the system 12. Alternatively, the liquid pump 22 can be located in the coupon receiving section 34 or the top section 70 with a conduit for drawing water from the bottom section 18 and to the appropriate area of the system 12 for use.

Wheels or a skid can be associated with the bottom section 18 for allowing maneuverability of the cabinet 14. This can provide additional portability or transportability of the cabinet 14.

A coupon rotation or roller assembly can be positioned, in part, in the bottom section 18 and/or the coupon receiving section 34, and can be configured to rotate a coupon 30 within the coupon receiving section 34. It can be appreciated that the coupon 30 includes a first coupon section 30a, a second coupon section 30b and a weld 32 connecting the two coupon sections together. The coupon rotation or roller assembly can include a first set of spaced apart rollers 24a configured to support a first coupon section 30a, and a second set of spaced apart rollers 24b configured to support a second coupon section 30b. Each set of rollers 24a, 24b can include multiple pairs of spaced apart rollers capable of rotatably supporting their respective coupon section 30a, 30b. For example, the first set of rollers 24a can include one, two, three or more pair of rollers, and the second set of rollers 24b can include the same or different number of pair of rollers.

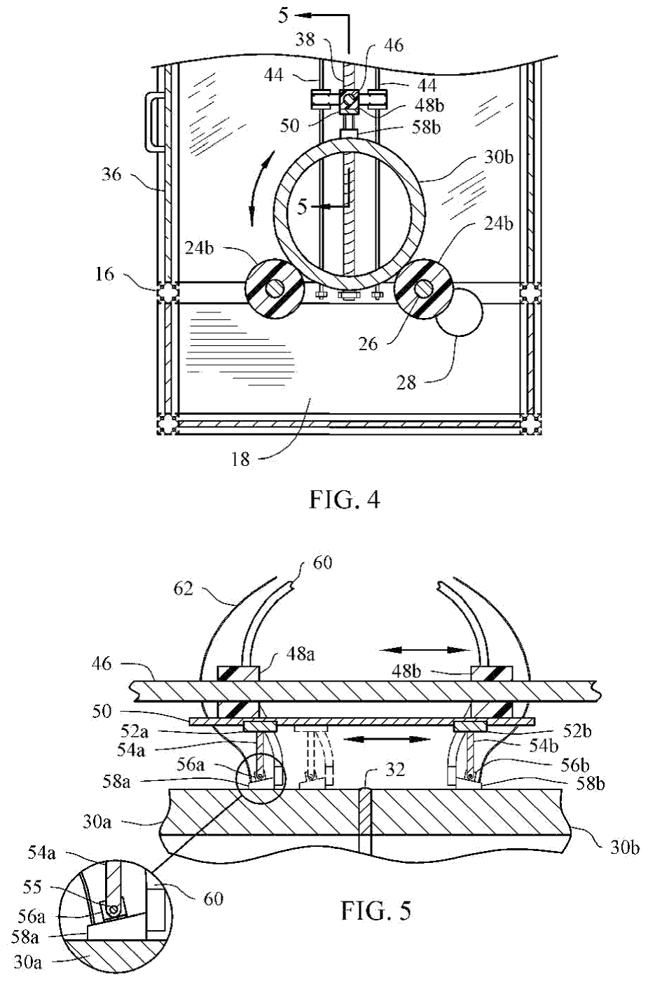

As best illustrated in FIGS. 4-6, a roller motor 28 is operably connected to any one of or both of the first and second sets of rollers 24a, 24b to providing rotation of the rollers and consequently the coupon 30 supported by the rollers 24a, 24b. It can be appreciated that multiple roller motors can be utilized to provide independent rotation of each of the rollers. It can be further appreciated that a gearing, belt or transmission system can be utilized to drive any one or all the rollers 24a, 24b. Same sided first and second rollers 24a,24b can be rotatably supported by an axle or shaft 26, respectively. This can provide the roller assembly as a module unit capable of being moved to different locations on the frame 16, removed and/or replaced. The rollers 24a, 24b can be made of a material capable of supporting the coupon 30 while still griping the coupon 30 to providing rotation and/or braking. A braking operation on the coupon 30 can be applied by controlling an operation of the roller motor 28, consequently slowing down the rollers 24a, 24b and thus the coupon 30.

The coupon receiving section 34 includes an interior chamber defined by wall panels that can be transparent allowing for therein. The interior chamber of the coupon receiving section 34 is configured to receive the coupon 30 by way of openable panels or doors 36.

The gantry system can in part be associated in the coupon receiving section 34 for positioning a set of spaced apart ultrasonic probes 58a, 58b on to the first and second coupon sections 30a, 30b, respectively. The gantry system can include a single y-axis ball screw or vertical drive member 38 or a set of oppositely located y-axis ball screws or vertical drive members 38. Each of the vertical drive members 38 can be, but not limited to, a ball screw device, a power screw, a slide rail, a solenoid or a hydraulic/pneumatic cylinder. One or more vertical member motors 40, which can be a stepper motor, are operably connected to at least one of the vertical drive members 38 for providing rotation thereto. The vertical member motors 40 can be located in an upper area of the coupon receiving section 34 or the top section 70. In some embodiments, a single ultrasonic transceiver may be utilized in place of the set of ultrasonic probes 58a, 58b, where the set may include an ultrasonic transmitter and an ultrasonic receiver.

A vertical block 42 can be operably coupled to each of the vertical drive members 38 for substantially vertical movement of the vertical block 42 upon rotation of the vertical drive members 38 by the vertical member motors 40. In the exemplary, each of the vertical blocks 42 can include a threaded bore that is engageable with a threaded section of the vertical drive members 38.

Vertical position sensors 43 can be associated with the vertical drive members 38, the vertical member motors 40 and/or the vertical blocks 42. The vertical position sensors are configured or configurable to determine a position of the vertical blocks 42 along the vertical drive members 38. In the exemplary, the vertical position sensors 43 can be contact switches located a specific locations along the vertical drive member 38 and/or on any one of or both of the vertical blocks 42. It can be appreciated that the vertical position sensors 43 can be, but not limited to, distance sensors, laser sensors, travel sensors, and the like.

One or more vertical guide members 44 can be positioned adjacent to each of the vertical drive members 38 to guide movement of the vertical block 42. In some embodiments, the vertical guide members 44 can be a vertically oriented linear slide rail positioned on either side of the vertical drive member 38. Each linear slide rail can include a corresponding sliding carriage with a connector spanning thereacross and attachable to the vertical block 42. In some embodiments, the vertical guide members 44 can be vertically oriented rods that slidably contact a side of the vertical block 42 or the vertical block 42 can define bores therethrough configured to slidably receive the vertical guide rods.

The gantry system can further include a horizontal drive member 46 having an end rotatably connected to each of the vertical blocks 42. One end of the horizontal drive member 46 can be rotatably associated with a first vertical block 42 of a first vertical drive member 38, while a second and opposite end of the horizontal drive member 46 can be rotatably associated with a second of the vertical block 42 of a second vertical drive member 38. Accordingly, the horizontal drive member 46 would extend from and between the vertical drive members 38. The horizontal drive member 46 can be, but not limited to, a ball screw device, a power screw, a slide rail, a solenoid or a hydraulic/pneumatic cylinder with its ends rotatably received or supported by the vertical blocks 42, respectively.

A horizontal member motor 47 can be operably connected to the horizontal drive member 46 for providing rotation thereto. The horizontal member motor 47 can be, but not limited to, a stepper motor. The horizontal member motor 47 can be supported by either one of the vertical blocks 42, or can be associated with a horizontal motor block (not shown) that travels along one of the vertical drive members 38.

Two or more horizontal blocks 48a, 48b can operably coupled to the horizontal drive member 46 to provide horizontal movement of the horizontal blocks 48a, 48b upon rotation of the horizontal drive member 46 by the horizontal member motor 47. The horizontal blocks 48a, 48b can be spaced apart on the horizontal drive member 46 so that a first horizontal block 48a is associated with the first coupon section 30a, and a second horizontal block 48b is associated with the second coupon section 30b so that the weld 32 is positioned therebetween. Each of the horizontal blocks 48a, 48b can be independently located or positionable on the horizontal drive member 46. In the exemplary, each of the horizontal blocks 48a, 48b can include a threaded bore that is engageable with a threaded section of the horizontal drive member 46.

Supported by or suspending from each of the horizontal blocks 48a, 48b is at least one ultrasonic probe 58a, 58b for contact with the first and second coupon sections 30a, 30b, respectively.

As best illustrated in FIG. 5, a linear slide rail 50 can be attachable to each of the horizontal blocks 48a, 48b for horizontal movement with the horizontal blocks 48a, 48b upon rotation of the horizontal drive member 46. One or more carriages 52a, 52b are each slidable supported on the linear slide rail 50 independent of each other. A first carriage 52a is associated with the first coupon section 30a, and a second carriage 52b is associated with the second coupon section 30b, with the weld 32 positionable therebetween. A locking mechanism can be associated with each of the carriages 52a, 52b to lock the carriages in position along the linear slide rail 50.

A support member 54a, 54b extends from each of the carriages 52a, 52b, and can be adjustable in length. Each of the probes 58a, 58b can include a probe wedge or probe mount 56a, 56b that is pivotably connected to an end of the support member 54a, 54b, respectively. The pivoting action can be accomplished by a pivot pin 55 passing through the support member 54a, 54b and the probe mount 56a, 56b, thereby providing pivoting or rotation of the probes 58a, 58b in relation to a longitudinal axis of the coupon 30. Alternatively, the pivoting action can be accomplished by a ball and socket connection between the support member 54a, 54b and the probe mount 56a, 56b, thereby providing pivoting or rotation of the probes 58a, 58b in relation to the longitudinal axis and a lateral axis of the coupon 30. This allows for each probe 58a, 58b to be angularly oriented for contact with their corresponding coupon section 30a, 30b. Each of the probes 58a, 58b can be in combination with the computer system 207 by way of cabling/wiring 62.

A liquid supply tube 60 can be associated with each of the carriages 52a, 52b, each of the support members 54a, 54b or each of the probes 58a, 58b. The liquid supply tube 60 is in communication with the liquid pump 22 so that a liquid such as, but not limited to, water or coolant can be supplied by the liquid pump 22 to an outer surface of the first and second coupon sections 30a, 30b and/or the weld 32 and/or an area adjacent the probes 58a, 58b.

Horizontal position sensors 49 can be associated with the horizontal drive member 46, the horizontal member motor 47 and/or the horizontal blocks 48a, 48b. The horizontal position sensors are configured or configurable to determine a position of the horizontal blocks 48a, 48b along the horizontal drive member 46. In the exemplary, the horizontal position sensors 49 can be contact switches located a specific locations along the horizontal drive member 46 and/or on any one of or both of the horizontal blocks 48a, 48b. Still further or in the alternative, horizontal position sensors can be associated with the carriages 52a, 52b and/or the support members 54a, 54b. It can be appreciated that the horizontal position sensors 49 can be, but not limited to, distance sensors, laser sensors, travel sensors, and the like.

In another aspect, one or more horizontal guide members (not shown) can be positioned adjacent to each of the horizontal drive member 46 to guide movement of the horizontal blocks 48a, 48b. In some embodiments, the horizontal guide members can be a horizontal oriented linear slide rail positioned on either side of the horizontal drive member 46. Each linear slide rail can include a corresponding sliding carriage with a connector spanning thereacross and attachable to any one or any combination of the horizontal blocks 48a, 48b. In some embodiments, the horizontal guide members can be horizontal oriented rods that slidably contact a side of any one or any combination of the horizontal blocks 48a, 48b, or any one or any combination of the horizontal blocks 48a, 48b can define bores therethrough configured to slidably receive the horizontal guide rods.

The top section 70 of the cabinet 14 can have an interior chamber defined by wall panels and configured to contain the computer system 270, and can include a power button 72, a nearfield operator ID device 74, and the display/touchscreen 297.

The computer system 270 can be in operative communication with the liquid pump 22, the roller motor 28, the vertical member motors 40, the horizontal member motor 47, the vertical position sensors 43, the horizontal position sensors 49, the probes 58a, 58b, and any and all electrical components associated with the system 10. Additionally sensors that can be utilized with the present technology and/or in communication with the computer system 270 can be, but not limited to, distance sensors, contact sensors, temperature sensors, rotation sensors, speed sensors, flow sensors, level sensors, and the like.

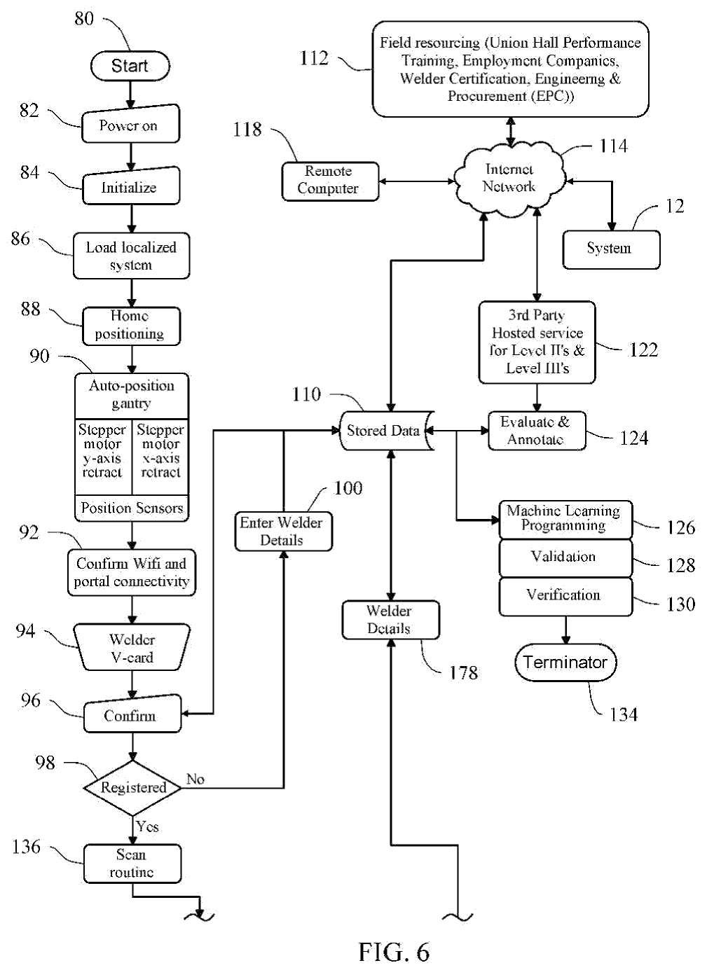

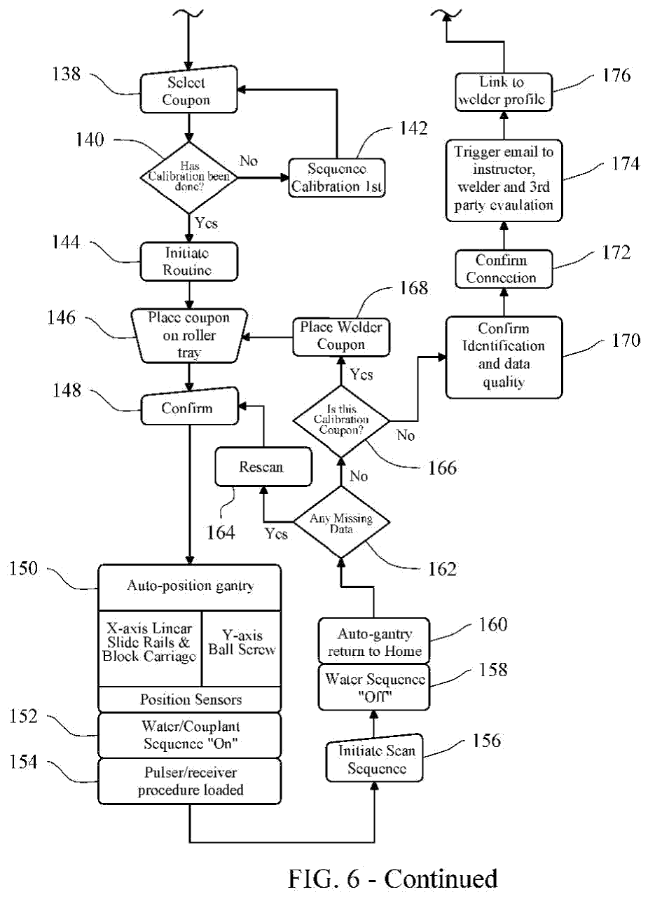

Referring to FIG. 6, a process of the present technology is described which provides operation of the present technology. For exemplary purposes, a software application can be initiated by the user for the automated operation of the system 12. The process can be configured or configurable to initiate subroutines and/or subprocesses to assist in the overall process of the present technology.

An initial step can be for the user to start the process 80 and power on (step 82) the system. After which, an initialization process is conducted (step 84). The process then proceeds to step 86 wherein a localized system or parameters are loaded.

Upon which, step 88 initiates a home positioning operation, which controls the auto-positioning of the gantry (step 90) by controlling the y-axis stepper motor and/or the x-axis stepper motor to their retracted positions. The position sensors can be utilized to provide control data for step 90.

After the gantry is retracted to its home position, step 92 then confirms Wifi and portal connectivity. Welder's information can be provided to the process (step 94) by any suitable means, for example but not limited to, manual entry, remote acquisition and the like. In some embodiments, the welder's information can be provided by way of a V-card that can then be scanned or inputted in to the process. In the exemplary, the V-card can include readable information associated with details of that particular welder, which can be provided by, but not limited to, a barcode or other optical readable code, a Near Field Communication (NFC) system, a Radio-frequency identification (RFID), a magnetic strip or any other known information transmission system. After which, step 96 confirms the welder's information, and this information is then determined if it is registered in step 98. The registration of the welder's information can be accomplished by comparison or cross-referencing with a database. If welder's information is not registered in step 98, then the process proceeds to step 100 that allows the welder details to be entered. The confirmation data from step 96 and the welder's details from step 100 can then be provided as stored data (step 110). The process is capable of created a new welder entry if the welder's information was found in step 98 to not be registered, thereby determining that the welder is a new entry and thus creating a new welder profile including the welder's information.

The stored data can be provided to the internet and/or network 114, which can be accessed by field resourcing 112, by the present technology system 12 and/or by a remote computer 118. In the exemplary, the field resourcing in step 112 can be utilized with or for, but limited to, union hall performance training, employment companies, welder certification, engineering procurement, etc.

Still further, third party hosted services for level II's and III's welder certifications can access (step 122) the stored data via the internet and/or network (step 114). This can provide rapid welder certification information to any authorized person. After which, step 124 can be initiated that provides evaluation and annotate from the third party hosted services to provide and/or receive information to the store data.

Even further, the stored data in step 110 can be provided to and/or receive data from machine learning programming (step 126), which can provide validation (step 128) and verification (step 130) of the information or any results from scans performed on the coupon. After which, the process can proceed to terminate (step 134).

An additional process can be continued from step 98 if the confirmation data is registered. If the result is “yes” then the process can proceed to step 136 where a scan routine is initiated. Upon which, a coupon is selected (step 138) and then step 140 proceeds to determine if a calibration has been done. If “no” then the process proceeds to step 142 which initiates one or more sequence calibrations, and then the process returns to step 138. It can be appreciated that this provides a process loop until a calibration has been done. A calibration coupon with a predetermined size or diameter and a predetermined weld can be utilized in the system for calibrating the system for operation.

When a calibration has been determined to be done in step 140, the process then proceeds to step 144 that initiates a routine. After which, a coupon can be placed on the roller assembly or tray (step 146), where confirmation of placement on the roller tray is confirmed (step 148). This can be accomplished by sensors capable of determining a coupon is positioned on the roller assembly. For example, a weight or contact sensor associated with one or more of the rollers, an image of the interior of the coupon receiving section, a laser sensor, and the like.

After step 148, an auto-positioning process is initiated on the gantry (step 150), wherein the x-axis linear slide rails or horizontal drive member and block carriage, and/or the y-axis ball screw or vertical drive members can be moved. The position of which can be determined by their respective position sensors. This can be accomplished by operating any one of or any combination of the vertical member motors and the horizontal member motor until the ultrasonic probes are in a predetermined or calculated position. Particularly, until the ultrasonic probes are in contact with their respective first and second coupon sections.

After the auto-positioning of the gantry is completed, the process can proceed to turning “On” a water/couplant sequence (step 152), and then an ultrasonic pulser/receiver procedure can be loaded (step 154). It can be appreciated that a couplant is a material (usually liquid) that facilitates the transmission of ultrasonic energy from a probe/transducer onto a test specimen. Couplant is sometimes necessary because the acoustic impedance mismatch between air and solids (i.e. such as the test specimen) is large.

Upon completion of step 154, the process can initiate a scan sequence (step 156), which can include the operation of the roller motor to rotate the coupon so that the entire length or circumference of the weld is imaged by the ultrasonic probes. After which, the water sequence can be turned “Off” (step 158) and the gantry can be automatically positioned to a Home position (step 160). The Home position can allow easy access into the interior of the coupon receiving section for removal of the coupon from the roller assembly. The ultrasonic probes provide data to the process for analysis and possible conversion into image data.

In step 162, the process can then determine if any data from the scan sequence is missing, has been omitted or is corrupted. If the result is “yes” then the process proceeds to step 164 where a rescan of the coupon is performed, and then the rescan is confirmed at step 148. It can be appreciated that steps 148-162 provide a process loop for initiating one or more scans of the coupon until there is no missing data per step 162.

When step 162 determines there is no missing data, then the process continues to determine if this is a calibration coupon (step 166). If the result is “Yes” that the coupon is a calibration coupon, then the process proceeds to step 168 where a welder's coupon (step 168) is placed on the roller tray and then the process returns to step 146. It can be appreciated that steps 146-166 provides a process loop for continued determination if the type of coupon that has been scanned until the coupon is not a calibration coupon (step 166).

When the coupon is not a calibration coupon as determined in step 166, the process then proceeds to step 170 that confirms identification and data quality. After this confirmation, the process then confirms communication connection (step 172). In the exemplary, this can be accomplished by a handshake, which is an automated process of negotiation between two participants through the exchange of information that establishes the protocols of a communication link at the start of the communication, before full communication begins. Data from the V-card and the scan sequence performed on the welder's coupon (determined to not to be a calibration coupon), can then be compiled for transmission and viewing.

Utilizing the communication connection, the process then triggers an email, text, message or any other type of communication to the instructor, the welder and/or the third party evaluation (step 174).

After which, a link to a welder profile can be provided (step 176). The welder profile can then be provided to the welder details (step 178), which can then be provided to the stored data (step 110). It can be appreciated that the stored data (step 110) can include the welder details entered in step 100 and/or the additional welder details from step 178 that can include the data from the scan sequence.

As described above, the stored data can then be provided to the internet and/or network connected systems, and/or to the machine learning programming.

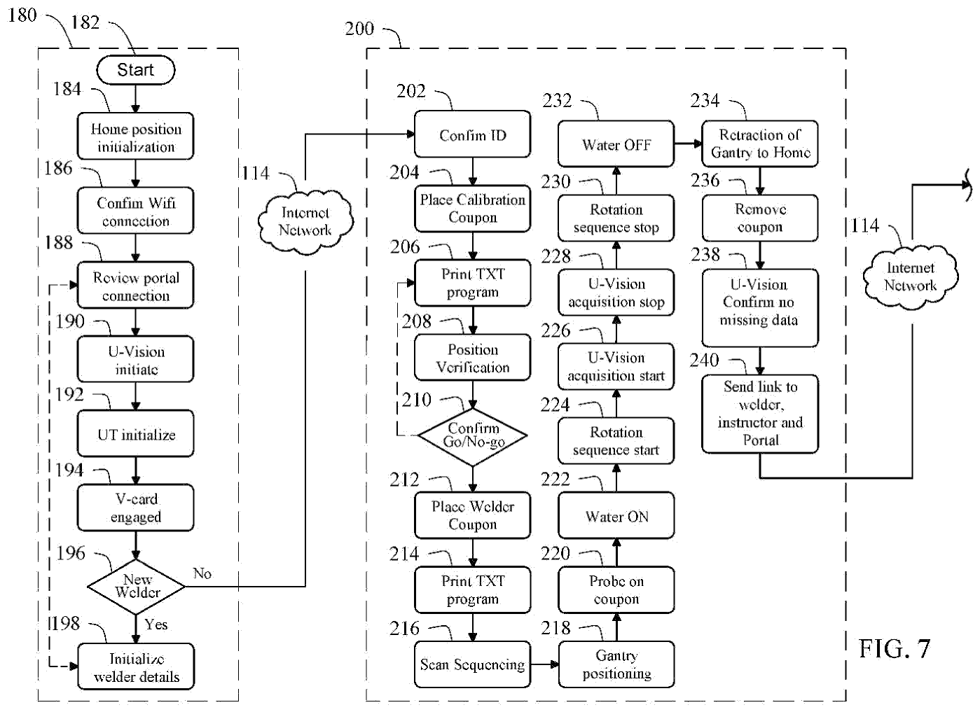

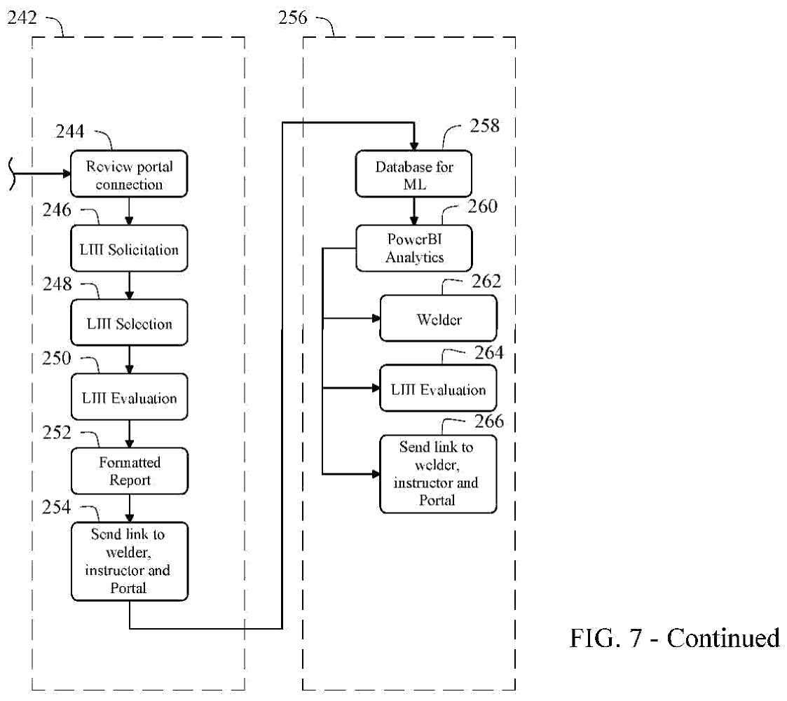

Referring to FIG. 7, an in use or a workflow of a process of the present technology is described which provides operation of the present technology. For exemplary purposes, the workflow process can include a set-up operation 180, a data acquisition operation 200 in communication with the set-up operation 180, an evaluation operation 242 in communication with the data acquisition operation 200, and an analytics operation 256 in communication with the evaluation operation 242.

The workflow process can begin with the set-up operation 180 where the process starts at step 182. After which, a Home position initialization process (step 184) can be conducted on the gantry to place the gantry in a Home position capable of receiving a coupon on the rollers.

The workflow can then continue to confirm a Wifi connection (step 186), and then to review portal connection (step 188). The portal can allow any authorized user access to the system and/or the data. For example, an instructor located remotely could access the welder data utilizing the portal operated by or stored in the computer system of the cabinet or on a remote computer system in communication with the cabinet. In the exemplary, the portal can include a user interface to access a welder certification profile including the results of the scan.

After step 188, the workflow can proceed to initiate the ultrasonic probes (U-Vision) in step 190, and then to initiate UT (step 192).

Welder's information can be provided, for example utilizing a V-card including the welder's details that can be read or inputted (step 197), and then the workflow can determine if this is a new welder (step 196). If the welder's information or the V-card data represents a new welder, then the workflow can proceed to step 198 to initialize welder details. The new welder details can then be provided back to step 186. It can be appreciated that steps 186-196 provides a workflow loop until the welder details from the welder's information or V-card is no longer determined as a new welder.

If step 196 determines that the welder's information or the V-card data is not associated with a new welder, then the workflow can then proceed to the data acquisition operation 200, and specifically to step 202 that confirms the identification (ID). The information from step 196 can be provided directly to step 202 in a same system or can be provided via the internet and/or network 114.

After ID confirmation, the user can then place a calibration coupon on the rollers (step 204). A print text (TXT) program can be initiated (step 206) on the calibration coupon, and position verification (step 208) can be operated. In the exemplary, the print TXT program can be a separate program or a subroutine that is can control the gantry, similar to a program for operating a 3D printer or a multi-axis Computer Numerical Controlled (CNC) machine. After step 208, the workflow can then determine a “Go” or “No-go” status (step 210) on the position verification. If a “No-go” status is determined in step 210, then the workflow returns back to step 206 until a predetermined position verification is provided to step 210.

When a “Go” status in step 210 is determined, then the workflow proceeds to placing a welder's coupon on the rollers (step 212). After which, a print TXT program (step 214) can be initiated on the welder's coupon.

The workflow can then proceed to step 216 where a scan sequence is initiated, including automatically positioning the gantry (step 218) and then placing or positioning the ultrasonic probes on the coupon (step 220).

After which, a water “ON” operation (step 222) is initiated that activates the liquid pump to provide water on to the coupon by way of the hose.

Then a rotation sequence is started (step 224) that activates the roller motor to rotate the coupon supported by the rollers. While the water is “ON” and the coupon is rotating, the workflow can then proceed to step 226 which starts the ultrasonic (U-Vision) acquisition. Upon one or more complete rotations of the coupon, the U-Vision acquisition is stopped (step 228). Thereafter, the rotation sequence is stopped (step 230) and the water is “OFF” (step 232).

Upon ceasing of rotation and water flow, the gantry is retracted to the Home position (step 234), thereby moving the horizontal drive member and its associated probes out of the way for removal of the coupon (step 236) from the rollers and consequently from the coupon receiving chamber.

The workflow can then proceed to step 238 to confirm if there is no missing data from the U-Vision. After which, a link can be sent to the welder, the instructor and/or the portal (step 240).

After step 240, the workflow can then proceed to the evaluation operation 242, and specifically to step 244 that reviews the portal connection. The information from step 240 can be provided directly to step 244 in a same system or can be provided via the internet and/or network 114. The portal can then be provided with welder level certification information or a welder certification profile including the results of the scan.

For example, a Level III solicitation (step 246) can be performed, followed by a Level III selection (step 248), and then followed by a Level III evaluation (step 250). It can be appreciated that any welder level class can be utilized in steps 246-250.

Next, a report is generated and formatted (step 252), and a link is sent to the welder, the instructor and/or the portal (step 254) that includes the formatted report.

After step 254, the workflow can then proceed to the analytics operation 256, and specifically to step 258 that stores the link and/or data from step 254 in a database for machine learning (ML).

After step 258, the data can then be provided to an analytics program or software package (step 260). For example, but not limited to, the analytics of the data can be processed by Power BI® (business intelligence) from Microsoft® that can provide a predictive analysis of advanced analytics to allow users to create predictive models from the data. It can be appreciated that step 260 can utilize a collection of software services, apps, and connectors that work together to turn unrelated sources of data into coherent, visually immersive, and interactive insights.

The analytics in step 260 utilizes machine learning algorithms for predictive modeling. The analytics can be local system based or cloud based, and be configured or configurable to provide visualized data directly to the welder (step 262).

Further, the analytics can be used for welder level evaluation (step 264), for example, if the welder meets the requirements for Level III certification. The analytics can further be provided in a link sent to the welder, the instructor and/or the portal (step 266). Accordingly, the analytics of the weld performed by the welder on the coupon can be available to any and all authorized people in or in almost real time. Therefore providing rapid quality or certification information of the welder.

It can be appreciated that remote 3rd party evaluation and reporting can be accomplished utilizing the link provided or the portal, along with onsite analytics of welder performance.

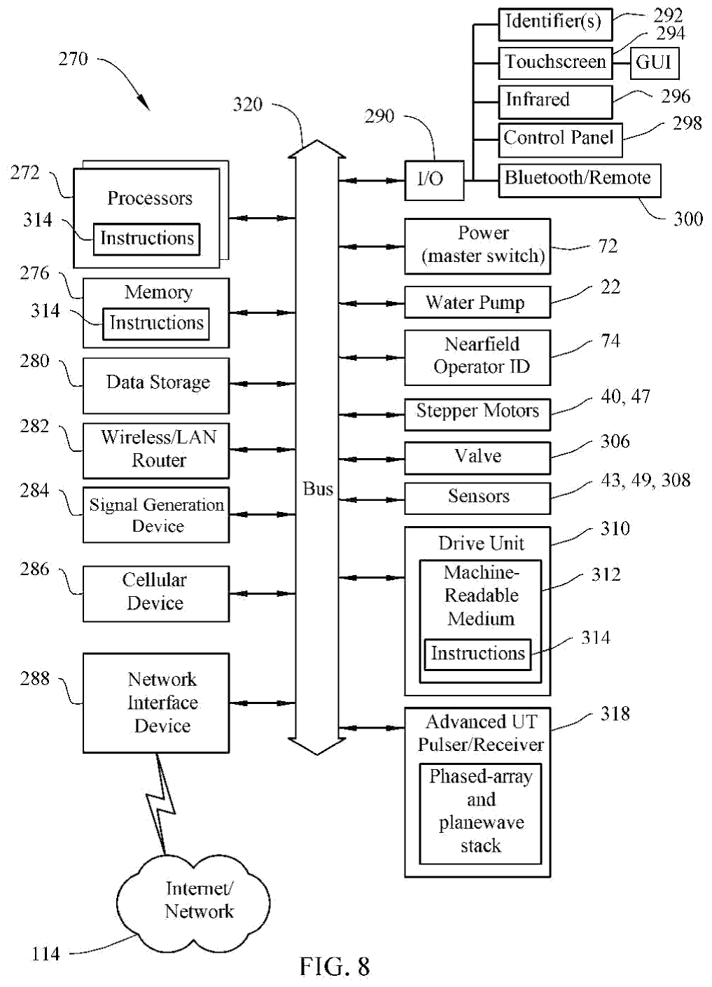

FIG. 8 is a diagrammatic representation of a computer system 270 that is utilizable or implementable with the system 10 and/or any peripheral component of the present technology. The computer system 270 can be part of an example machine, which is an example of one or more of the computers referred to herein and, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 270 includes a processor or multiple processors 272 (e.g., a central processing unit (CPU), a graphics processing unit (GPU), or both), a memory 276 and/or a data storage device 280, which communicate with each other via a bus 320. The computer system 270 may further include or be in operable communication with a wireless/LAN router 282, and a cellular device 286. The computer system 270 may also include input/output (I/O) devices 290, such as, one or more identifiers 292 (e.g., resettable identifier, biometric identifier, physical identifier, finger print reader, facial recognition, camera, RFID reader), a video display 294 with graphical user interface (GUI) (e.g., a liquid crystal display (LCD), touch sensitive display), an alpha-numeric input device(s) (e.g., a keyboard, keypad, touchpad, touch display, buttons), a cursor control device (e.g., a mouse), a voice recognition or biometric verification unit, an infrared receiver 296, a control panel 298 (e.g. buttons, switches, knobs), a master power switch 72, a near-field operator ID 74, and/or a Bluetooth/wireless remote 300. Even further, the computer system 270 can include or be in communication with the liquid pump 22, a valve 306, one or more sensors 308 (e.g., positions sensors 43, 49, distance sensors, contact sensors, temperature sensors, rotation sensors, speed sensors, flow sensors, level sensors), the vertical and/or horizontal member motors 40, 47, and the advanced UT pulser/receiver 318 that can include the ultrasonic probes 58a, 58b.

Still further, the computer system 270 can include a drive unit 310 (also referred to as disk drive unit), a signal generation device 284 (e.g., a speaker), and a network interface device 288. The computer system 270 may further include a data encryption module (not shown) to encrypt data. The drive unit 310 includes a computer or machine-readable medium 312 on which is stored one or more sets of instructions and data structures (e.g., instructions 314) embodying or utilizing any one or more of the methodologies or functions described herein. The instructions 314 may also reside, completely or at least partially, within the memory 276 and/or within the processors 272 during execution thereof by the computer system 270. The memory 276 and the processors 272 may also constitute machine-readable media.

The instructions 314 may further be transmitted or received over a network via the network interface device 288 utilizing any one of a number of well-known transfer protocols (e.g., Hyper Text Transfer Protocol (HTTP)). While the machine-readable medium 312 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

An example machine system of the present technology including the computer system 270 in combinational and/or operational use with components of the present technology. In the exemplary, any or all of the above-described components can include a processor 272, memory 276, a network interface device 288, a display 294, an input device(s) 290, and/or drive unit 310.

While embodiments of the ultrasound-based welder qualification system have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although automated rapid inspection and delivery of welder performance results during training in accordance with certification parameters have been described, it should be appreciated that the ultrasound-based welder qualification system herein described is also suitable for analyzing material of a tubular member utilizing ultrasonic technology and an automated system.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A weld qualification system comprising:
a roller assembly including multiple rollers each configured to rotatably support a coupon placed thereon, wherein the coupon includes a weld;
a gantry assembly including one or more vertical drive members and a horizontal drive member movable along the one or more vertical drive members; and
ultrasonic probes movably associated along the horizontal drive member, the ultrasonic probes being configured to contact an exterior surface of the coupon when supported by the roller assembly.

2. The weld qualification system according to claim 1, wherein the one or more vertical drive members is at least two vertical drive members in a spaced apart relationship with the coupon located therebetween.

3. The weld qualification system according to claim 2, wherein each of the one or more vertical drive members includes a vertical block configured to travel therealong upon rotation of at least one of the one or more vertical drive members by a vertical drive motor.

4. The weld qualification system according to claim 3, wherein the horizontal drive member includes a horizontal block configured to travel therealong upon rotation of the horizontal drive member by a horizontal drive motor, and wherein the horizontal drive member is operably connected to the vertical block of each of the one or more vertical drive members so that vertical motion of the vertical block translates into vertical motion of the horizontal drive member.

5. The weld qualification system according to claim 4, wherein the ultrasonic probes are operably connected to the horizontal block by away of a pivot connection.

6. The weld qualification system according to claim 3, wherein each of the one or more vertical drive members includes one or more vertical guide members configured to guide the vertical block as it travels along the one or more vertical drive members includes, respectively.

7. The weld qualification system according to claim 1, wherein each of the ultrasonic probes is movably associated with the horizontal drive member, and each being configured for contact with the exterior surface of the coupon on opposite sides of the weld.

8. The weld qualification system according to claim 1, wherein at least one of the rollers is rotatably driven by a roller motor.

9. The weld qualification system according to claim 1 further comprises a computer system including at least one processing unit operably connected or connectable to the gantry assembly and the ultrasonic probes, wherein the at least one processing unit is configured or configurable to control the gantry assembly, the ultrasonic probes, and to process data received from the ultrasonic probes.

10. The weld qualification system according to claim 1 further comprises a liquid pump configured to pump a liquid from an area below the coupon to the exterior surface of the coupon adjacent the ultrasonic probes.

11. The weld qualification system according to claim 10 further comprises a cabinet including a bottom section configured to receive or store the liquid, and a coupon receiving section configured to receive the coupon.

12. A method of using a weld qualification system for inspecting a weld on a coupon for determining welder qualification, the method comprising the steps of:
a) placing the coupon on a roller assembly;
b) activating a gantry assembly to position ultrasonic probes to contact an exterior surface of the coupon adjacent the weld;
c) rotating the coupon;
d) activating the ultrasonic probes;
e) imaging the weld utilizing the ultrasonic probes to create weld data; and
f) determining the welder qualification based on the weld data.

13. The method according to claim 12, wherein step b) further comprises the step of operating one or more vertical drive motors to rotate one or more vertical drive members of the gantry assembly to vertically move a vertical block along the one or more vertical drive members.

14. The method according to claim 13, wherein step b) further comprises the step of operating a horizontal drive motor to rotate a horizontal drive member of the gantry assembly to horizontal move a horizontal block along the horizontal drive member, and wherein the horizontal drive member is operably connected to the vertical block of the one or more vertical drive members so that vertical motion of the vertical block translates into vertical motion of the horizontal drive member.

15. The method according to claim 12, wherein step c) further comprises the step of operating a roller motor that is operably connected to one or more rollers of the roller assembly to rotate the coupon supported on the roller assembly.

16. The method according to claim 12, wherein step f) further comprises the step of analyzing the weld data utilizing a computer system including at least one processing unit operably connected or connectable to the two or more ultrasonic probes.

17. The method according to claim 16, wherein step f) further comprises the step of analyzing the weld data by the computer system utilizing any one of or any combination of one or more machine learning algorithms and one or more machine learning statistical models.

18. The method according to claim 12 further comprises, prior to step d), the step of operating a liquid pump to deliver a liquid to the exterior surface of the coupon adjacent the two or more ultrasonic probes.

19. A non-transitory computer readable medium with an executable program stored thereon comprising instructions for execution by at least one processing unit for inspecting a weld on a coupon for determining welder qualification, such that the instructions when executed by the at least one processing unit causes the at least one processing unit to:
activate any one of or any combination of a vertical drive motor and a horizontal drive motor of a gantry assembly to position ultrasonic probes to contact an exterior surface of the coupon adjacent the weld;
activate a roller motor operably connected to one or more rollers of a roller assembly to rotate the coupon supported on the roller assembly;
activate the ultrasonic probes;
image the weld utilizing the ultrasonic probes to create weld data; and
determine the welder qualification based on the weld data.
